(19) United States
(12) Patent Application Publication
(10) Pub. No.: US 2026/0222216 A1
(43) Pub. Date: Jul. 30, 2026

(54) DISTRIBUTED ENSEMBLE LEARNING METHOD BASED ON BLOCKCHAIN

(71) Applicant: Southeast University, Nanjing, Jiangsu (CN)

(72) Inventors: Xintong LING, Nanjing, Jiangsu (CN); Zixiang CUI, Nanjing, Jiangsu (CN); Yan LU, Nanjing, Jiangsu (CN); Jiaheng WANG, Nanjing, Jiangsu (CN); Xiqi GAO, Nanjing, Jiangsu (CN)

(21) Appl. No.: 19/145,767

(22) PCT Filed: Oct. 28, 2024
(86) PCT No.: PCT/CN2024/127661

§ 371 Date: Jul. 3, 2025

(30) Foreign Application Priority Data
Sep. 9, 2024 (CN) 202411256074.1

(51) Int. Cl. H04L 9/32; G06N 20/00; H04L 9/00

(52) U.S. Cl. CPC H04L 9/3236; G06N 20/00; H04L 9/50

(57) ABSTRACT

The present disclosure discloses a distributed ensemble learning method based on a blockchain. Based on the designed three-layer blockchain structure formed by MiniBlocks, Ensemble Blocks, and Key Blocks and through a consensus protocol, the base model is trained on the training dataset, which is randomly sampled with replacement, by the miners in the network, and the base models from other miners are aggregated, and eventually, the information of the base models and the ensemble models are recorded on the blockchain, so that the entire process of the model training, model aggregation, and model evaluation is integrated into the blockchain consensus mechanism, and the entire ensemble learning process can be automatically executed in the blockchain network. Therefore, in the present disclosure, the proof-of-useful-work mechanism's utilization of the computing power in blockchain networks is improved, and the central nodes are avoided in the model aggregating process, which maximizes the degree of decentralization in blockchain.

### CROSS-REFERENCE TO RELATED APPLICATIONS

The present application claims the priority to Chinese Patent Application No. 2024112560741, filed with the Chinese Patent Office on Sep. 9, 2024 and entitled “distributed ensemble learning method based on blockchain”, which is incorporated in its entirety herein by reference.

### TECHNICAL FIELD

The present disclosure relates to the technical field of blockchains, and especially related to a distributed ensemble learning method based on a blockchain.

### BACKGROUND

Blockchain is a distributed data storage technology that ensures the consistency of the data copies on all nodes in an unreliable peer-to-peer network through the consensus protocol and the incentive mechanism. The consensus protocol is the cornerstone of the blockchain, and the design of the consensus protocol fundamentally determines the performance characteristics of the blockchain system, including throughput, consistency, scalability, and robustness. Currently, the Proof of Work (PoW) protocol is one of the most popular consensus protocols. In a PoW-based system, miners attempt to generate new blocks by finding a nonce such that the resulting block hash is below a target value. However, in the mining process, a lot of energy is consumed, and most of the energy is wasted in meaningless hash calculations.

At present, the solutions for solving the sustainable problem in the PoW protocol are divided into two categories. One is to reduce the amount of the computation in the consensus process, the other is the proof-of-useful-work (PoUW) protocol. In the latter, the practical computing tasks are used as the proof of work to meet the computing power demands from third parties. In existing POUW protocols, the machine learning and the optimization tasks are mainly utilized as the proof-of-useful-work. In frontier research, mining pools in PoW systems are transformed into clusters of miners competing for machine learning training rewards by combing federated learning with blockchain consensus, and the models generated by each mining pool are aggregated into a global model through the FedAvg algorithm.

In the above POUW protocol utilizing machine learning and federated learning, a single model is selected as the wining model and the remaining models are discarded in most machine learning-based POUW solutions, which inevitably leads to inefficient utilization of computing power. As for the existing federated learning-based consensus mechanisms, although the models are trained in a distributed manner by the data holders, the robustness of these protocols is constrained by the central nodes because the models are commonly aggregated by one or a plurality of central nodes. Therefore, it is required to develop a technology that can aggregate the computing power of each node in a decentralized blockchain network.

### SUMMARY

Inventive objectives: in view of the problems of the inefficient utilization of computing power and insufficient decentralization in existing POUW protocols, the objectives of the present disclosure are to design a three-layer blockchain structure formed by MiniBlocks, Ensemble Blocks and Key Blocks, as well as a distributed ensemble learning method based on a blockchain, to improve the utilization of the computing power in blockchain networks, avoid the introduction of central nodes in the model aggregation process, and maximize the degree of decentralization in blockchain.

Technical solutions: in order to achieve the above-mentioned objectives of the present disclosure, the following technical solutions are adopted in the present disclosure. According to one aspect of the present disclosure, provided is a three-layer blockchain structure enabling a distributed ensemble learning task to be executed, and the three-layer block structure includes the following components.

MiniBlocks, each MiniBlock corresponds to a unique base model, and the MiniBlock includes the identifier of machine learning model parameters, the identifier of the owner of a model, the hash value of a previous Key Block, the hash value of the machine learning task, and a timestamp.

Ensemble Blocks, the Ensemble Block includes the performance metrics of an ensemble model on a validation dataset, the identifier of a model aggregator, the hash value of an aggregated base model corresponding to the MiniBlock, the hash value of the machine learning task, and a timestamp.

Key Blocks, the Key Block includes the hash value of the previous Key Block, the hash value of the machine learning task, an identifier of the miner generating block, performance metrics of an optimal ensemble model on a test dataset, a timestamp indicating when the Key Block is generated, the root hash of a Merkle tree carrying transactions, a nonce, a task queue, the hash value and performance metric of each Ensemble Block involved in ranking.

According to one aspect of the present disclosure, provided is a method for generating a three-layer blockchain structure enabling a distributed ensemble learning task to be executed, and the method includes the following steps:

MiniBlocks are generated and broadcast after a base model is trained by a miner on a training dataset, each MiniBlock corresponds to a unique base model, and the MiniBlock includes the identifier of machine learning model parameters, the identifier of the owner of a model, the hash value of a previous Key Block, the hash value of the machine learning task, and a timestamp.

Ensemble Blocks are generated and broadcast after the base models are aggregated by the miner and the performance is evaluated on a validation dataset, each Ensemble Block includes the performance metric of an ensemble model on the validation dataset, the identifier of a model aggregator, the hash value of an aggregated base model corresponding to the MiniBlock, the hash value of the machine learning task, and a timestamp.

A Key Block is generated and broadcast after the performance metrics of the collected ensemble models are evaluated by the miner on a test dataset and an optimal ensemble model is selected. The Key Block includes the hash value of the previous Key Block, the hash value of the machine learning tasks, the identifier of the miner generating the Key Block, the performance metric of the optimal ensemble model on the test dataset, a timestamp indicating when the Key Block is generated, the root hash of the Merkle tree carrying transactions, a nonce, a task queue, and the hash value and performance metric of each Ensemble Block involved in ranking.

According to one aspect of the present disclosure, provided is a distributed ensemble learning method based on a blockchain, and the method includes the following steps.

In Step \textcircled{1}, a training dataset, a validation dataset and a test dataset are prepared by a task publisher in advance, machine learning tasks are published through a blockchain transaction, the tasks include the hash values of the training dataset, the validation dataset, and the testing dataset as well as scripts for implementing base model training, base model aggregation, and performance evaluation.

In Step \textcircled{2}, task information is validated by a miner, and the task information is forwarded to other miners.

In Step \textcircled{3}, the training dataset is downloaded from the task publisher, when a previous Key Block is generated by the miner, or a previous valid Key Block is received from other miners. After the training dataset is downloaded, the base models are trained by the miner, and then the MiniBlock is generated and broadcast.

In Step \textcircled{4}, the validation dataset is published by the task publisher. After the validation dataset is received by the miner, the base models are aggregated by the miner and the performance metrics of the aggregated base models are evaluated on a validation dataset, and then an Ensemble Block is generated and broadcast.

In Step \textcircled{5}, the test dataset is published by the task publisher. After the test dataset is received by the miner, the performance metrics of the collected ensemble models are evaluated on the test dataset to select an optimal ensemble model, the hash value of the Key Block is calculated, and then the Key Block is generated and broadcast.

In Step \textcircled{6}, the performance metrics of the optimal ensemble model and corresponding base model parameters are retrieved by the task publisher from the Key Block, and an ensemble model with an ideal performance can be obtained by aggregating the base models.

Preferably, in one embodiment of the present disclosure, the machine learning tasks published by a user through the blockchain transaction includes a transaction serving as training fees, and the training fees are transferred to a virtual address by the transaction.

Preferably, in one embodiment of the present disclosure, the miners generating the Key Blocks and the MiniBlocks are rewarded, the training fees of the task publisher are evenly distributed to all miners generating base models used by a winning ensemble model, and the miners generating the Key Block are rewarded by newly-generated tokens.

Preferably, in one embodiment of the present disclosure, local private data and public training data provided by the task publisher are together utilized by the miner for base model training, so that the quality of the base model is enhanced and the quality of the ensemble model is improved.

Preferably, in one embodiment of the present disclosure, the ensemble model is obtained by aggregating the base models through the Bagging algorithm.

Preferably, in one embodiment of the present disclosure, a computer system is provided, the computer system includes a memory, a processor, and a computer program/instruction stored in the memory and executable on the processor, when the computer program/instruction is executed, the steps of the aforementioned method are implemented.

Preferably, in one embodiment of the present disclosure, a computer-readable storage medium storing a computer program is provided. When the computer program is executed by a processor, the steps of the aforementioned method are implemented.

Preferably, in one embodiment of the present disclosure, a computer program product is provided, the computer program product includes a computer program/instruction, when the computer program/instruction is executed by a process, the steps of the aforementioned method are implemented.

The distributed ensemble learning method based on the blockchain provided in the present disclosure has the following benefits.

(1) In the present disclosure, the distributed ensemble leaning process is embedded into the generation, validation, and propagation processes of three types of blocks by designing a three-layer blockchain structure to implement the execution of the distributed ensemble learning tasks in the blockchain.

(2) In comparison with the existing machine learning-based PoUW protocol, in the present disclosure, the ensemble learning process is executed in an automatic and distributed manner in blockchain networks, and the ensemble model having better performance is formed through aggregating a plurality of base models trained by the miners, the qualities of the based models and the ensemble models are further improved through allowing the miners to use the private data, and when the private data of different miners is non-independent and identically distributed, the ensemble model obtained by aggregating the base models still has a good performance.

(3) In comparison with the proof-of-federated-learning mechanism, in the present disclosure, the base models are aggregated without mining pool administrators, which can operate on the public chain and have a higher degree of decentralization.

(4) In the present disclosure, an incentive mechanism is designed to encourage the miners to participate in maintaining the blockchain, training models, integrating models, and evaluating models, so that the blockchain based on the present disclosure is robustly and sustainably operated.

(5) The performance of the ensemble model generated by the present disclosure can be improved with the increase of the quantity of the miners that train the base models with private data in the blockchain.

The additional aspects and advantages of the present disclosure will be partially presented in the following descriptions, some of which will become apparent from the following descriptions, or learned through the practice of the present disclosure.

### BRIEF DESCRIPTION OF THE DRAWINGS

The above and/or additional aspects and advantages of the present disclosure will become apparent and easily understood from the following descriptions of the embodiments in combination with the accompanying drawings.

FIG. 1 illustrates a schematic diagram of a three-layer blockchain structure enabling a distributed ensemble learning task to be executed according to an embodiment of the present disclosure.

FIG. 2 illustrates a general flow chart of a distributed ensemble learning method based on a blockchain according to an embodiment of the present disclosure.

FIG. 3 illustrates a schematic diagram of various phases of a task execution process in a distributed ensemble learning method based on a blockchain according to an embodiment of the present disclosure.

FIG. 4 illustrates a line chart of the performance boost of the ensemble model generated by an embodiment of the present disclosure in comparison with the base model and the model obtained and solely trained on the public data under different public dataset ratios.

FIG. 5 illustrates a line chart of the accuracy of the ensemble model generated by an embodiment of the present disclosure under different network scales and network connectivity.

### DETAILED DESCRIPTIONS OF THE EMBODIMENTS

The technical solutions of the present disclosure are described in detail below with reference to the accompanying drawings and the specific embodiments. It should be understood for those skilled in the art that the embodiments described below with reference to the accompanying drawings are exemplary and intended to be used to explain the present disclosure, but should not be construed as defining the present disclosure.

A distributed ensemble learning method based on a blockchain in an embodiment of the present disclosure is described below with reference to the accompanying drawings. In view of the problems of the inefficient utilization of computing power and insufficient decentralization in the existing POUW protocols mentioned in the above background, a distributed ensemble learning method based on a blockchain is provided by an embodiment of the present disclosure, which integrates a plurality of models trained by miners through the Bagging algorithm. The model training, model aggregation, and model evaluation processes can be automatically executed by the disclosed three-layer blockchain structure and the distributed ensemble learning method in a fully decentralized public chain.

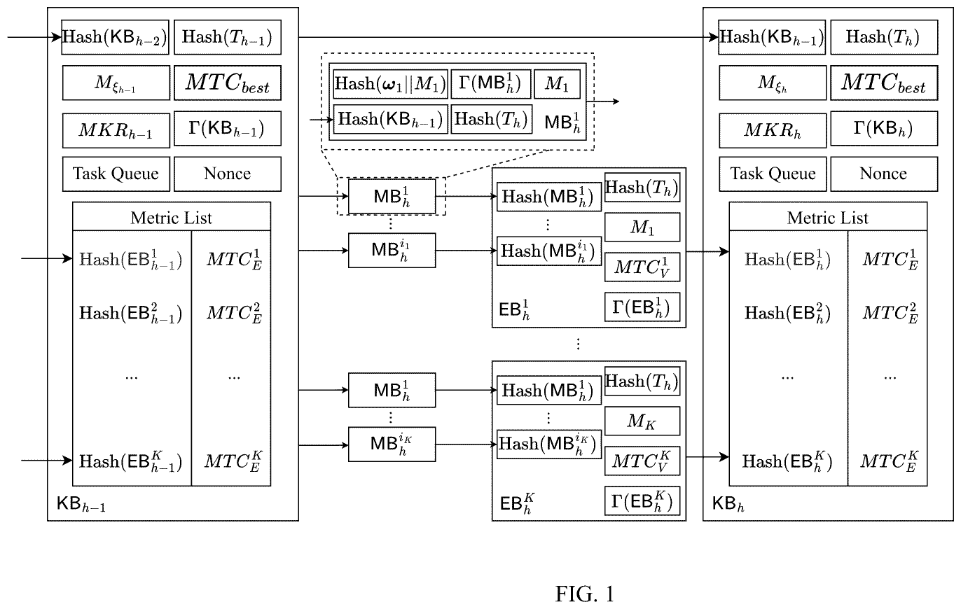

Specifically, a three-layer blockchain structure enabling a distributed ensemble learning task to be executed according to an embodiment of the present disclosure is illustrated in FIG. 1.

As illustrated in FIG. 1, provided is three types of data structures contained in the three-layer blockchain structure and the interconnections among the three types of data structures.

MiniBlocks (denoted as

$${MB}_{h}^{i}$$

) are configured to record the ownership of the model and the hash value of the model parameters. Each MiniBlock corresponds to a unique base model and includes the identifier Mᵢ of the model owner, the identifier Hash(ωᵢ∥Mᵢ) calculated after connecting the machine learning model parameters with the miner identifier, the hash value Hash(KBₕ₋₁) of a previous Key Block, the hash value of the machine learning task Hash(Tₕ) and a timestamp

$$Γ ( {MB}_{h}^{i} ) .$$

Ensemble Blocks (denoted as

$$E {B}_{h}^{k}$$

) are configured to record the base models required for each ensemble model, and the performance metrics of the ensemble model on the validation dataset. The Ensemble Block is pointed to a plurality of MiniBlocks, and one ensemble model can be obtained through aggregating the base models corresponding to the MiniBlocks. The Ensemble Block includes the performance metrics

$$M T {C}_{V}^{k}$$

of the ensemble model on the validation dataset D_{V}, the identifier (Mₖ) of the model aggregator, the hash values

$$Hash ( {MB}_{h}^{1} ) , … , Hash ( {MB}_{h}^{{i}_{k}} )$$

of the aggregated base models, the hash value Hash(Tₕ) of the machine learning task, and a timestamp

$$Γ ( {EB}_{h}^{i} ) .$$

Key Bocks (denoted as KBₕ) are configured to store the blockchain transaction, the task queue, the ensemble model rank, etc. The Key Block includes the hash value Hash(KBₕ₋₁) of the previous Key Block, the hash value Hash(Tₕ) of the machine learning tasks, the identifier M_{ξh} of the miner generating blocks, the performance metrics MTC_{best} of the optimal ensemble model on the test dataset D_{E}, a timestamp

$$Γ ( {KB}_{h}^{i} )$$

indicating when the Key Block is generated, the root hash MKRₕ of the Merkle tree carrying transactions, the nonce, the task queue, the hash value

$$Hash ( {EB}_{h}^{j} )$$

of each Ensemble Block involved in ranking, the performance metric

$$M T {C}_{E}^{j}$$

of the ensemble model corresponding to the

$$E {B}_{h}^{j}$$

on the test dataset D_{E}.

A method for generating the three-layer blockchain structure which can enable the distributed ensemble learning tasks to be executed is provided by an embodiment of the present disclosure. The main steps for the method are as follows. After the base model trainings are completed by the miner on the training dataset, the MiniBlocks in the structure illustrated in FIG. 1 are generated and broadcast, after the base models are aggregated by the miner and the performance metrics of the aggregated models are evaluated on the validation datasets, the Ensemble Blocks in the structure illustrated in FIG. 1 are generated and broadcast, and after the performance metrics of the collected Ensemble models are evaluated on the test datasets, the optimal ensemble model is selected, and the Key Blocks in the structure illustrated in FIG. 1 are generated and broadcast.

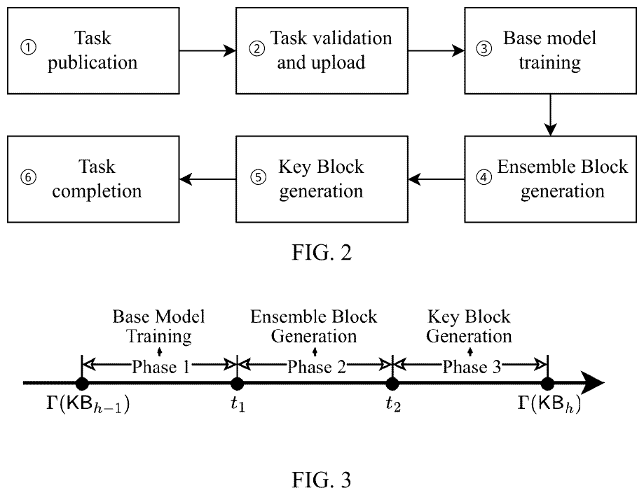

As illustrated in FIG. 2 and FIG. 3, a distributed ensemble learning method based on the blockchain provided by an embodiment of the present disclosure is illustrated in FIG. 2, and a schematic diagram of each phase of the task execution process in the distributed ensemble learning method based on the blockchain is illustrated in FIG. 3.

In Step \textcircled{1}, “Task publication” in FIG. 2, the training dataset, the validation dataset, and the test dataset are prepared by the task publisher in advance, and the machine learning tasks are published through the blockchain transactions. The machine learning tasks include the hash values of the training dataset, the validation dataset, and the test dataset as well as scripts for implementing base model training, model aggregation, and performance evaluation. The machine learning task further includes a transaction for paying the model training fees, which is transferred to a virtual address in the transaction.

In Step \textcircled{2}, “Task validation and upload” in FIG. 2, the task information is validated by the miner and forwarded to other miners, and the task is eventually added to the task queue of the Key Block.

Step \textcircled{3} to Step \textcircled{5} in FIG. 2 are the task execution process. The first phase (Phase 1, Base Model Training) in FIG. 3 corresponds to Step \textcircled{3} “Base Model Training” in FIG. 2, the second phase (Phase 2, Ensemble Block Generation) in FIG. 3 corresponds to Step \textcircled{4}) “Ensemble Block generation” in FIG. 2, and the third phase (Phase 3, Key Model Generation) in FIG. 3 corresponds to Step \textcircled{5} “Key Block generation” in FIG. 2.

The task execution process in the embodiment of the present disclosure includes the following three phases.

When the Key Block KBₕ₋₁ with a block height of h−1 is generated by the miner, the first phase of the task execution process is triggered. When the KBₕ₋₁ is received by the miner Mᵢ and KBₕ₋₁ passes validation, the miner Mᵢ starts to train a base model. When one or more valid forks are received by the miner Mᵢ, the longest fork is selected (that is, a chain with maximal height). When the tips of these forks have the same height, then the fork where the Key Block with the optimal MTC_{best} is located is selected as the main chain, and the task at the current height is executed on the main chain. Once the KBₕ₋₁ is confirmed by the miner Mᵢ, the task that is ranked first in the task queue of the KBₕ₋₁ is selected, and the public training dataset D_{T} is downloaded, and the D_{T} and the private dataset D_{M}, are merged into a local dataset D_{T}_{ᵢ}. Subsequently, the training script is executed by the miner on the local dataset D_{T}_{ᵢ}, and the parameter ωᵢ of the base model is generated. Once the base model is prepared, the timestamp

$$Γ ( {MB}_{h}^{i} ) ,$$

the identifier Mᵢ of the miner, the task hash Hash(Tₕ), the model parameter identifier Hash(ωᵢ|Mᵢ) and the Hash(KBₕ₋₁) are encapsulated into the

$${MB}_{h}^{i}$$

by the miner Mᵢ, and the

$${MB}_{h}^{i}$$

is broadcast to the blockchain network. The MiniBlocks are received and broadcast to the neighboring miners by the miner before the second phase, but the base models are not transmitted outwards to avoid the model plagiarism.

The validation dataset D_{V} can be disclosed by the task publisher at tᵢ to trigger the second phase of the task execution process. Once the validation dataset is received by the honest miner Mᵢ, the new MiniBlock is rejected, and the following steps are executed. (1) The validation dataset D_{V} is downloaded, and the model parameter ωⱼ is obtained based on the identifier Hash(ωⱼ∥Mⱼ) extracted from the

$$M {B}_{h}^{j} ;$$

(2) All the collected MiniBlocks are validated by the miner Ma, when the Key Block pointed to by the MiniBlock is invalid, or the downloaded model parameter ωⱼ does not match the identifier Hash(ωⱼ∥Mⱼ), or the performance metric of the base model corresponding to the MiniBlock on the validation dataset is less than the minimum tolerance value given by the task publisher, the MiniBlock is considered invalid and all the invalid MiniBlocks are discarded by the miner Mᵢ; (3) The ensemble model formed by aggregating the base models corresponding to all the valid MiniBlocks is evaluated by the miner Mᵢ by utilizing the validation dataset D_{V} to obtain the performance metric

$${MTC}_{V}^{i} ;$$

(4) The timestamp

$$Γ ( {MB}_{h}^{i} ) ,$$

the identifier Mᵢ of the miner, the task hash Hash(Tₕ), the performance metric

$${MTC}_{V}^{i}$$

obtained through the evaluation and the hash values

$$Hash ( {MB}_{h}^{j} )$$

of the MiniBlocks corresponding to all the aggregated base models are encapsulated into the

$${EB}_{h}^{i}$$

and broadcast to the blockchain network. Before the start of the third phase, when any Ensemble Block

$$E {B}_{h}^{q}$$

from other miners is received by the miner, the

$$E {B}_{h}^{q}$$

is validated by the miner and forwarded to the neighboring miners.

The test dataset D_{E} can be disclosed by the task publisher at t₂ to trigger the third phase of the task execution process. After receiving the test dataset D_{E}, the miner Mᵢ evaluates all the validated Ensemble Blocks by utilizing the test dataset D_{E} and then attempts to generate a new Key Block. It is assumed that the Ensemble Blocks

$${EB}_{h}^{1} , … , {EB}_{h}^{K}$$

are validated by the miner Mᵢ, and the

$${EB}_{h}^{j}$$

is pointed to the

$$M {B}_{h}^{j , 1} , … , {MB}_{h}^{j , {μ}_{j}} ,$$

and the

$$M {B}_{h}^{j , l}$$

includes Hash(ω_{i,l}∥Mₗ), where nⱼ denotes the number of the MiniBlocks

$$E {B}_{h}^{j}$$

points to, l denotes a positive integer that is not greater than ηⱼ, ω_{j,l} is generated by the miner Mₗ. Then, K performance metrics

$$M T {C}_{E}^{j}$$

are calculated by the miner Mᵢ to find the optimal performance metric MTC_{best} among the series of the

$$M T {C}_{E}^{j} .$$

It is assumed that the

$$M T {C}_{E}^{q}$$

is the optimal performance metric, then all the components of the Key Block are loaded into the candidate block [symbol] Bₕ by the miner Mᵢ. A valid Key Block [symbol] Bₕ that satisfies Hash( [symbol] Bₕ)<Target is eventually found by the miner, and the [symbol] Bₕ is broadcast by the miner before receiving the valid Key Block KBₕ from other miners. When a valid Key Block KBₕ from other miners is received before a valid Key Block [symbol] Bₕ is found and broadcast, then the Key Block [symbol] Bₕ is discarded and the first phase of the machine learning task Tₕ to be executed at block height h is started by the miner. Herein, Target is a static threshold that controls the difficulty of the Key Block generation, and is equivalent to the target value in the PoW consensus.

In Step \textcircled{6} “Task completion” in FIG. 2, the base model parameters can be downloaded by the task publisher from the blockchain network with the help of the Key Block KBₕ at block height h, and an ensemble model with expected performance can be obtained by the task publisher after aggregating the base models.

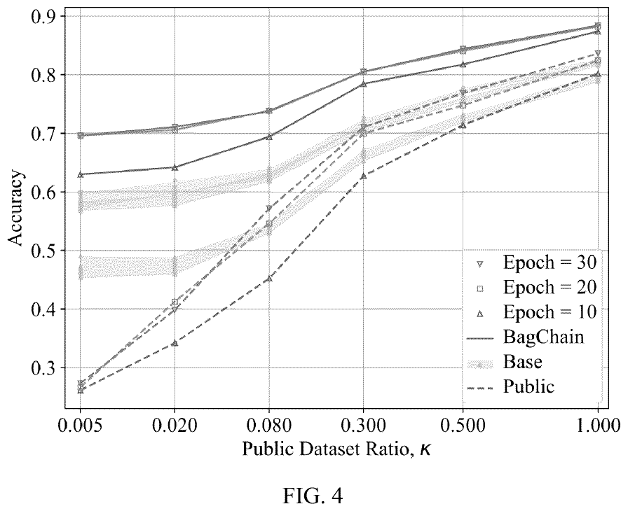

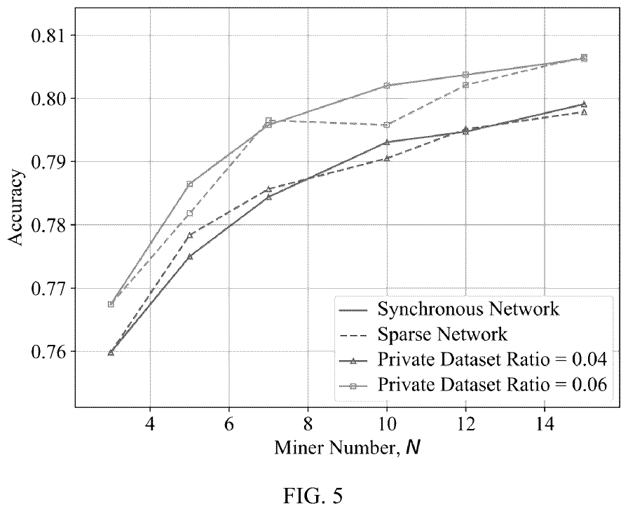

In order to reveal the performance of the present disclosure in the actual work, with reference to FIG. 4 and FIG. 5, evaluations of a typical embodiment of the present disclosure are performed, and the evaluation results are recorded and shown as follows.

The performance boost of the ensemble model (BagChain) generated by the present disclosure in comparison with the base model (Base) and the model (Public) solely trained on the public data under different public dataset ratios is illustrated FIG. 4. It can be seen that the accuracy of the ensemble models on the test dataset is better than any of their base models. When the public dataset ratio (Public Dataset Ratio) K is less than 0.3, the performance of the model trained on the public dataset is worse than that of the base model trained with both private and public data, which can demonstrate the value of the present disclosure, because when all miners have the private datasets that can be used for the machine learning tasks, the task publisher can obtain the high-quality machine learning model from the present disclosure. It can further be observed that the accuracy of the base models and the ensemble models in the present disclosure are both improved with the increase of the public dataset ratio K, because the increase of the public dataset ratio k leads to an increase in the data samples in the local training dataset of the miner, thereby generating more accurate base models and ensemble models. In addition, the difference between the ensemble models obtained after training the base models for 20 and 30 epochs can be negligible, which indicates that 20 epochs are sufficient to generate a sufficiently excellent base model, and the aggregated model has an ideal performance, thus illustrating that base model training in the present disclosure is lightweight. Therefore, more resource-constrained nodes can participate in the model training without fine-tuning the machine learning model, and the models can be aggregated to improve the performance of the ensemble model in the present disclosure.

More generally, the private datasets of different miners may be non-independent and identically distributed, which is reflected in the imbalance of the quantity of the labels in each category in the miners' private datasets, and the machine learning models trained on these private datasets have significant biases. However, even if the imbalance exists in the private datasets of the miners, the ensemble model generated in the present disclosure still has significant performance advantages in comparison with the base model and the model trained solely on public data, and the performance of the ensemble model is almost unaffected by the imbalance in the quantity of labels when the public dataset ratio K is relative large, that is, in the present disclosure, the influence of the imbalance in the quantity of the labels in the private datasets of the miners can be offset by increasing the quantity of the public training data samples, to a certain extent.

The accuracy of the ensemble model generated by the present disclosure under different network scales and network connectivity is illustrated in FIG. 5. In the figure, the Sparse Network is a network model with worse connectivity than the fully-connected Synchronous Network. It can be seen that, the average accuracy on the test dataset is increased with the increase in the quantity of the miners (Miner Number), because as the network scale is expanded, more private data and computing power are invested in base model training. In addition, the accuracy of the ensemble model generated by the present disclosure is significantly improved by the higher private dataset ratio (Private Dataset Ratio), which indicates that in the present disclosure, the performance of the ensemble model is improved under higher levels of miner participation and private data abundance. In addition, the comparison of the accuracy under the two network models shows that in the sparse network model, the performance of the present disclosure is basically unaffected, which highlights the robustness of the present disclosure in a more severe network environment.

A distributed ensemble learning method based on blockchain is disclosed by the present disclosure. In the method, a three-layer blockchain structure formed by MiniBlocks, Ensemble blocks, and Key blocks is designed, and by designing a consensus protocol, the base model is trained on the training dataset, which is randomly sampled with replacement, by the miners in the network, the base models from other miners are aggregated, and eventually, the information of the base models and the ensemble models are recorded on the blockchain, so that the entire process of model training, model aggregation, and model evaluation is integrated into the blockchain consensus mechanism. In the method, the entire process of the ensemble learning can be executed in an automatic and distributed manner, the proof-of-useful-work mechanism's utilization of the computing power in blockchain networks is improved, and the central nodes are avoided in the model aggregating process, which maximizes the degree of decentralization in blockchain.

A computer system is provided by an embodiment of the present disclosure, the system includes a memory, a processor, and a computer program/instruction stored in the memory and executable on the processor, and when the computer program/instruction is executed by a processor, the steps of the aforementioned method are implemented.

A computer-readable storage medium is provided by an embodiment of the present disclosure. The computer-readable storage medium is configured to store a computer program, and when the computer program is executed by a processor, the steps of the aforementioned method are implemented.

A computer program product is provided by an embodiment of the present disclosure. The computer program product includes a computer program/instruction, and when the computer program/instruction is executed by a processor, the steps of the aforementioned method are implemented.

1. A three-layer blockchain structure enabling a distributed ensemble learning task to be executed, comprising:
MiniBlocks, wherein each MiniBlock corresponds to a unique base model, and the MiniBlock includes an identifier of machine learning model parameters, an identifier of an owner of a model, a hash value of a previous Key Block, a hash value of a machine learning task, and a timestamp;
Ensemble Blocks, wherein the Ensemble Block includes a performance metric of an ensemble model on a validation dataset, an identifier of a model aggregator, hash values of the MiniBlocks corresponding to aggregated base models, the hash value of the machine learning task, and a timestamp; and
Key Blocks, wherein the Key Block includes the hash value of the previous Key Block, the hash value of the machine learning task, an identifier of a miner generating the Key Block, a performance metric of an optimal ensemble model on a test dataset, a timestamp indicating when the Key Block is generated, a root hash of a Merkle tree carrying transactions, a nonce, a task queue, a hash value and a performance metric of each Ensemble Block involved in ranking.

2. A method for generating a three-layer blockchain structure enabling a distributed ensemble learning task to be executed, wherein the method includes following steps:
generating and broadcasting, after a base model is trained by a miner on a training dataset, MiniBlocks, wherein each MiniBlock corresponds to a unique base model, and the MiniBlock includes an identifier of machine learning model parameters, an identifier of an owner of a base model, a hash value of a previous Key Block, a hash value of a machine learning task, and a timestamp;
generating and broadcasting, after the base models are aggregated by the miner and a performance metric is evaluated on a validation dataset, Ensemble Blocks, wherein each Ensemble Block includes a performance metric of an ensemble model on the validation dataset, an identifier of a model aggregator, hash values of the MiniBlocks corresponding to aggregated base models, the hash value of the machine learning task, and a timestamp; and
selecting, after the performance metrics of the collected ensemble models are evaluated by the miner on a test dataset, an optimal ensemble model to generate and broadcast a Key Block, wherein the Key Block includes the hash value of the previous Key Block, the hash value of the machine learning task, an identifier of a miner generating the Key Block, a performance metric of the optimal ensemble model on the test dataset, a timestamp indicating when the Key Block is generated, a root hash of a Merkle tree carrying transactions, a nonce, a task queue, and a hash value and a performance metric of each Ensemble Block involved in ranking.

3. A distributed ensemble learning method based on a blockchain, wherein the method includes following steps:
preparing, by a task publisher, a training dataset, a validation dataset, and a test dataset in advance; publishing, through a blockchain transaction, machine learning tasks, wherein the tasks include hash values of the training dataset, the validation dataset, and the testing dataset as well as scripts for implementing a base model training, a model aggregation, and a performance evaluation;
validating, by a miner, task information; and forwarding the task information to other miners; downloading, when a previous Key Block is generated by the miner, or a previous valid Key Block is received from other miners, the training dataset from the task publisher; training, after the training dataset is downloaded, the base model by the miner; then generating and broadcasting, after the base model is trained, a MiniBlock; wherein the MiniBlock includes an identifier of machine learning model parameters, an identifier of an owner of the model, a hash value of a previous Key Block, a hash value of a machine learning task and a timestamp;
publishing, by the task publisher, the validation dataset; beginning, after the validation dataset is received by the miner, to aggregate the base model by the miner and evaluating a performance metric of the aggregated base models on a validation dataset; then generating and broadcasting, after the performance metric is evaluated, an Ensemble Block, wherein the Ensemble Block includes a performance metric of an ensemble model on the validation dataset, an identifier of a model aggregator, a hash value of the MiniBlocks corresponding to the aggregated base models, the hash value of the machine learning task, and a timestamp;
publishing, by the task publisher, the test dataset; beginning, after the test dataset is received by the miner, to evaluate a performance metric of a collected ensemble model on the test dataset to select an optimal ensemble model; calculating a hash value of a Key Block and generating and broadcasting the Key Block, wherein the Key Block includes the hash value of the previous Key Block, the hash value of the machine learning task, an identifier of a miner generating the Key Block, a performance metric of the optimal ensemble model on the test dataset, a timestamp indicating when the Key Block is generated, a root hash of a Merkle tree carrying transactions, a nonce, a task queue, and a hash value and a performance metric of each Ensemble Block involved in ranking; and
retrieving, by the task publisher, the performance metric of the optimal ensemble model from the Key Block and corresponding base model parameters; and obtaining, through the aggregated base model, an ensemble model with an expected performance.

4. The distributed ensemble learning method based on the blockchain according to claim 3, wherein the machine learning task published by a user through the blockchain transaction includes a transaction serving as training fees, and the training fees are transferred to a virtual address by the transaction.

5. The distributed ensemble learning method based on the blockchain according to claim 3, wherein the miners generating the Key Block and the MiniBlocks are rewarded, training fees of the task publisher are evenly distributed to all the miners generating the base models used by a winning ensemble model, and the miners generating the Key Block are rewarded by newly-generated tokens.

6. The distributed ensemble learning method based on the blockchain according to claim 3, wherein local private data and public training data provided by the task publisher are together utilized by the miner for the base model training.

7. The distributed ensemble learning method based on the blockchain according to claim 3, wherein the ensemble model is obtained by aggregating the base models through a Bagging algorithm.

8. A computer system, including a memory, a processor, and a computer program/instruction stored in the memory and executable on the processor, wherein when the computer program/instruction is executed, the steps of the method according to claim 2 are implemented.

9. A computer-readable storage medium storing a computer program, wherein when the computer program is executed by a processor, the steps of the method according to claim 2 are implemented.

10. A computer program product, including a computer program/instruction, wherein when the computer program/instruction is executed by a process, the steps of the method of claim 2 are implemented.
